(19) United States
(12) Patent Application Publication
(10) Pub. No.: US 2020/0318992 A1
(43) Pub. Date: Oct. 8, 2020

(54) PILOTS RULER

(71) Applicants: VINCENT GIGLIO, Chesterfield, VA (US); Armand Patronella, Heber City, UT (US)

(72) Inventors: VINCENT GIGLIO, Chesterfield, VA (US); Armand Patronella, Heber City, UT (US)

(21) Appl. No.: 16/837,628

(22) Filed: Apr. 1, 2020

Related U.S. Application Data
(60) Provisional application No. 62/890,449, filed on Aug. 22, 2019.
(60) Provisional application No. 62/919,874, filed on Apr. 2, 2019.

(51) Int. Cl. G01C 22/00; G01D 5/30

(52) U.S. Cl. CPC G01C 22/00; G01D 5/30

(57) ABSTRACT

An apparatus, configured to measure a takeoff distance of an aircraft, the apparatus including a wheel rotation sensor; and a computing device, wherein the wheel rotation sensor is configured to measure wheel rotations, generate a wheel rotation signal and transmit the wheel rotation signal to the computing device, wherein the computing device is configured to start counting wheel rotations from the wheel rotation signal when the wheel rotation signal increases from zero, wherein the computing device is configured to stop counting the wheel rotations and store a rotation count when the wheel speed signal decreases, and wherein the computing device is configured to compute a takeoff roll distance of the aircraft from the rotation count and an aircraft wheel diameter.

### RELATED APPLICATIONS

This application claims benefit of US provisional patent application 62/919,874, filed on Apr. 1, 2019 and US provisional patent application 62/890,449 filed on Aug. 22, 2019, both of which are incorporated in their entirety by this reference.

### FIELD OF THE INVENTION

The pilot's ruler is a device that gives a pilot exact takeoff and landing distances for a particular aircraft in which the pilot's ruler is incorporated that is more precise than the takeoff and landing distances given in a flight manual or pilot operating handbook (POH) of an aircraft type.

### BACKGROUND OF THE INVENTION

Flight manuals (FM) and POHs typically give a takeoff roll distance and a climb distance over a 50 ft. obstacle and a landing distance over a 50 ft. obstacle that includes a landing roll distance. These distances are determined during a flight testing and certification process of an aircraft type and the data in the FM/POH is based on averages.

During certification and over time individual aircraft, however typically differ from the test aircraft due to weight increase that may not be recorded in the POH, aerodynamic modifications, antennas, non-conformance or contamination of aircraft surfaces and variations in engine performance etcetera. Accordingly, there is a need in the art to improve the takeoff and landing distances information provided to pilots.

### BRIEF SUMMARY OF THE INVENTION

The pilot's ruler is designed to give the pilot a much more precise takeoff and landing distance for an aircraft in which the pilot's ruler is installed. The pilot's ruler can be set up to measure takeoff or landing distance over a 50 ft. obstacle. (Industry standard for aircraft certification) The Pilot Operating Handbook/Aircraft Flight Manual for any general aviation, corporate aviation or commercial aircraft do not give exact distances for each individual aircraft at a location. These manuals were designed to give averages and not exact numbers. Aircraft that have been modified over the years will have different performance values that are not captured in the POH/AFM. The pilot's ruler will give exact distances based on captured data for the plane which it is installed.

An object of the invention is achieved by an apparatus, configured to measure a takeoff distance of an aircraft. The apparatus includes a wheel speed sensor, and a computing device. The wheel speed sensor is configured to measure a wheel speed, generate a wheel speed signal and transmit the wheel speed signal to the computing device. The computing device is configured to start counting wheel rotations from the wheel speed signal when the wheel speed signal increases from zero and the computing device is configured to stop counting the wheel rotations and store a rotation count when the wheel speed signal decreases. The computing device is configured to compute a takeoff roll distance of the aircraft from the rotation count and an aircraft wheel diameter.

Another object of the invention is achieved by a method for measuring a takeoff distance of an aircraft. The method includes starting a wheel rotation count when a wheel speed of the aircraft increases from zero, stopping the wheel rotation count when the wheel speed decreases, and computing a takeoff roll distance of the aircraft from the wheel rotation count and an aircraft wheel diameter.

The pilot's ruler will not need FAA (Federal Aviation Administration) approval because it is not mounted permanently to the aircraft and is considered to be a temporary installation requiring no FAA certification. However, a permanently installed pilot's ruler may also be install provided FAA approval is received.

The sensor pod may be mounted under the fuselage or on the wing and the sensor pod will transmit information via a transmitter to a handheld device which contains, for example, a PLC (Programmable Logic Controller) and a small touch screen to enter data or start the program. Once the data is transmitted from the optical retro reflective sensor and a global positioning system (GPS) signal will be captured by the pilot's ruler program and viewed for analysis. Once the actual data from the takeoff or landing roll is in the program, the actual data will be utilized with the local METAR (weather conditions at the airport at the time of departure) for that airport and the weight of the aircraft that was previously loaded by the pilot or another person on the touch screen. Once all of the data is captured, the data will be presented in a suitable format such as a modifiable spreadsheet or a graph for pilot analysis. The data presented to a pilot may include wheel size, aircraft weight, takeoff or landing distance, altitude, location, runway heading, temperature, density altitude, barometric pressure, wind speed and direction, and any other desired information. The METAR from the local airport may be used to supplement the pilot's ruler data from the unit. This data may be saved and filed for future comparisons. Each takeoff or landing can be captured for the pilot to determine actual performance data for their specific aircraft, compare it with published FM/POH numbers and develop their own calibrated performance charts though modification and interpolation of the published performance charts.

The pilot can determine go or no go decisions based on previous captured data from an airport of similar type. For example, the 1.5 rule to increase runway length for a contaminated runway of, for example, snow, heavy rain or gravel may be compared to actual data for a specific aircraft type.

The sensor pod may contain an optical retro reflective sensor (e.g., retro reflective beam sensor), battery pack, transmitter and circuit board. The signals from the optical retro reflective sensor will be transmitted to the pilot's ruler computing device in the cockpit. The optical retro reflective sensor will transmit wheel RPM. The sensor pod is a battery powered unit not requiring aircraft power. The shape of the sensor pod may be an aerodynamic shape.

Wheel RPM measurements are used to determine takeoff and landing roll in feet or meters by utilizing a target on the wheel to measure the wheel RPM. The measurement is initiated when the go or stop button is pushed or aircraft is stopped. The wheel RPM is determined using an optical retro reflective sensor directed to a target on the wheel to calculate distance traveled. RPM is converted to feet or meters.

The computing device may include a programmable logic controller and printed circuit board which runs the software to operate the pilot's rule. The software will take the information from the GPS and the optical retro reflective sensor capturing wheel rotations and send this data to the touch screen for viewing. The software is programmed to perform specific functions to make the program more accurate. When the wheel speed slows after lift off the program will stop counting rotations but will have the ability depending on the tire size to build in a delay to “back up” the last rotation or several rotations to increase accuracy. The speed reduction of the wheel after it loses ground contact is a function of bearing and brake drag but is also influenced by aerodynamics. In addition, while the aircraft is going down the runway, if the landing gear strut extends and retracts a large amount like a car hitting a pothole the counter will know this, and continue to count ignoring the loss of optical retro reflective sensor signal from the reflective sticker. The lost rotation will be averaged for the runway used to complete the equation. The same pothole correction is for landing but the optical retro reflective sensor stops counting on the landing roll only when the aircraft comes to a complete stop or when the stop button is pushed.

A WAAS (wide area augmentation system) GPS antenna is used to determine heights or can be programmed when to capture the data such as a 50 ft. obstacle or left un-programmed it will continue to capture data up to any altitude. The altimeter function on the touch screen will be set to 0 when the program is initiated or turned on. Field elevation can be displayed as a reference but in order to capture aircraft performance data over a 50 ft. obstacle the program will show 0 altitude in a box of the touch screen of the computing device regardless of field elevation at the airport.

The WAAS GPS antenna is used to show location, map overlay or to show altitude to a preset point to calculate performance data.

Advantageously the sensor pod is mounted with the optical retro reflective sensor facing a reflective target that will be placed on the tire which can be a reflective tape, retroreflective tape, a valve stem cap or the like so that the optical retro reflective sensor can sense the wheel rotations.

Once the software registers a decrease or stop in wheel speed (rotations/time interval) the beam will turn off and the wheel rotations will no longer be sensed. The location of the sensor pod will vary based on application. The sensor pod can be mounted via double sided tape, suctions cups or use a preexisting hole to fasten it. It should not be more than 3-4 meters from the target on the wheel. The tire valve cap can be replaced with a reflective or retroreflective type valve cap or reflective tape can be applied to the tire.

The pilot's ruler operates as follows. A snap shot of the local weather conditions should be taken to interface with the data to be taken. This may be done manually prior to the start of the program or alternatively it may be done automatically by addressing a database with the local weather conditions. The weather snap shot should be as close to departure time as possible. The weather snap shot can be interfaced with the program before or after the flight. Aircraft takeoff and landing weight is critical to performance data and can be added to the spreadsheet. The software application may be started via touchscreen or any other suitable way. Once the computing device is opened the external unit powers on and begins to connect to the sensor pod. The unit will start to track distance travelled on the runway when the go button is pushed on the touch screen or other input device or it will stop when the stop button is pushed after landing. In the takeoff mode it will initiate the sensors and start to track distance travelled on the runway. The sensors will determine wheel rotations, altitude and GPS location.

Wheel rotations will be converted to distance measured in, for example, feet or meters, based on tire diameter. (configured in the setup of the pilot's ruler program) Altitude is used by the program the program when to start or stop measurements based on the preprogrammed altitude. If the programmed altitude is not set then the pilot's ruler will track only wheel rotation which is converted to distance. When the aircraft takes flight the landing gear wheel speed decreases due to bearing friction, brake friction and aerodynamic drag the sensor pod will stops counting wheel rotations and the GPS signal will continue to track distance used from the point when the aircraft takes flight to the preset altitude.

In the landing mode, in order to get the most accurate results a complete stop after landing will be required. Altitude can be preprogrammed or not. If altitude for the landing is not programmed then the pilot's rule will capture landing distance once the optical retro reflective sensor senses wheel spin up. When altitude is programmed in the landing mode it will show GPS distance traveled from the from a WAAS antenna signal preprogrammed altitude. The software has the ability to “back up” the altitude in the program which can be delayed from the satellite to give more accurate results.

This “back up” may be applied to the preprogrammed altitude and wheel speed in the takeoff or landing mode. Each flight can be saved to a file in the pilot's ruler program and kept for future evaluation.

The more data captured and saved the better understanding of how a specific aircraft will perform on any given day or airport. This gives the pilot added confidence in their equipment.

The pilot's ruler is especially useful for flight test departments during aircraft certification and for acceptance trials when an aircraft buyer wishes to verify contractually defined performance parameters regardless whether the aircraft is new, used or modified.

The above uses wheel rotations and wheel circumference to determine distance (number of rotations X wheel circumference). Alternatively, wheel speed in RPMs, time and wheel circumference may be used to determine distance (average RPM X time X wheel circumference).

### BRIEF DESCRIPTION OF THE DRAWINGS

Further advantageous embodiments and improvements can be derived from the appended drawing figures. The details and features that can be derived from the figures are not limited to the embodiments illustrated in the figures. Rather one or plural features can be combined with one or plural features from the description provided supra to form new embodiments. In particular the subsequent descriptions do not define limitations of the scope of the invention but they describe individual features and their possible cooperation, wherein:

FIG. 1 illustrates an aircraft with the apparatus according to the invention in a front view; and

FIG. 2 illustrates a side view of the sensor pod for the apparatus according to FIG. 1;

FIG. 3 illustrates a bottom view of the sensor pod for the apparatus according to FIG. 1;

FIG. 4 illustrates a data screen of the computing device of the apparatus according to FIG. 1;

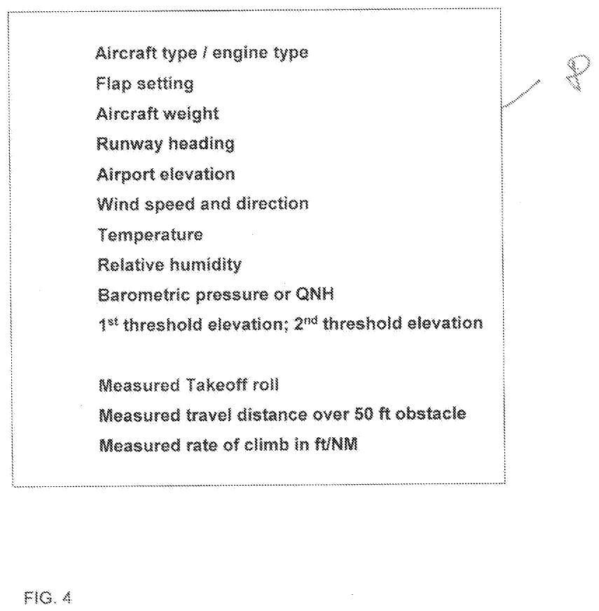

FIG. 5 illustrates a typical takeoff performance chart; and

FIG. 6 illustrates a derivation of a calibrated performance curve from a handbook performance curve.

### DETAILED DESCRIPTION OF THE INVENTION

In the drawing figures identical or like components are designated with identical reference numerals. The drawing figures merely show embodiments and do not limit the spirit and scope of the invention.

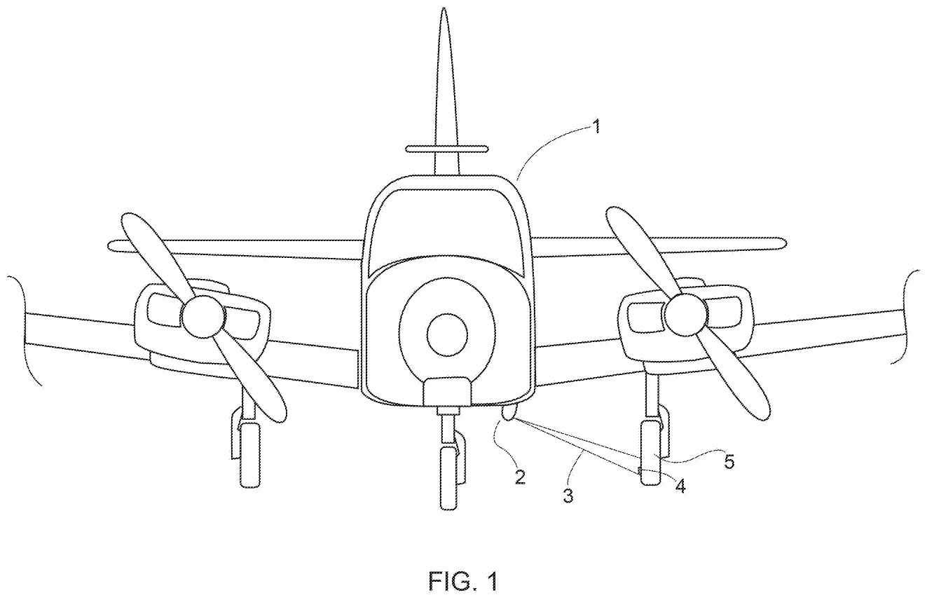

FIG. 1 illustrates a front view of an aircraft 1 with a sensor pod 2. The sensor pod 2 emits a light target beam or laser target beam 3 that is reflected by a reflective target 4 mounted on an aircraft wheel 5. The sensor is advantageously configured as an optical retro reflective sensor. The rotation of the aircraft wheel 5 generates periodic reflections of the light target beam or laser target beam 3 that are received by a beam receiver 6 in the sensor pod 2 and transmitted or input into a processor 7 in the sensor pod 2. The wheel rotation signal is transmitted to a computing device 8 in the aircraft cockpit wirelessly or by a hard line.

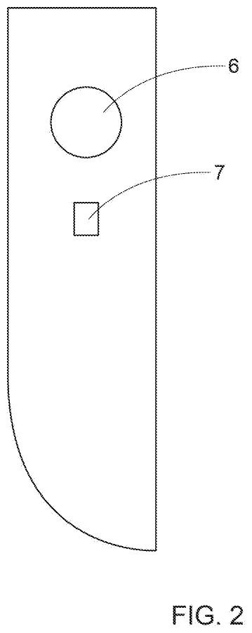

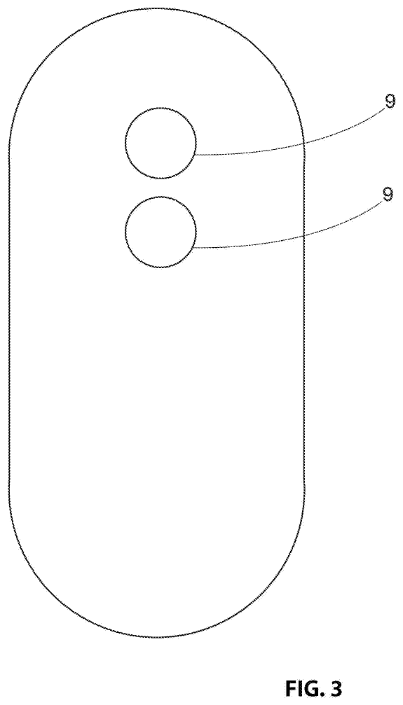

FIG. 2 illustrates a side view of the sensor pod 2 showing the laser receiver 6 and the processor 7. FIG. 3 illustrates laser ports 9 of the sensor pod that can be used for a radar altimeter that supplements the GPS altitude reading.

In order to initiate a takeoff measuring sequence the pilot initiates the sequence by hand when the aircraft 1 is stopped or the pilot arms the unit while the aircraft 1 is in motion to its starting position so that the takeoff measuring sequence is initiated when the aircraft 1 accelerates from its stop.

As soon as the aircraft 1 accelerates from the stop the computing device 8 starts counting wheel rotations. The pilot has the ability to enter wheel diameters into the computing device 8 so that the computing device 8 computes a distance travelled from the stop.

The computing device 8 keeps counting wheel rotations as long as the wheel speed increases during the takeoff run. Wheel speed can be determined from the number of wheel rotations over time. Once the aircraft wheel 5 leaves the ground it is not being driven any more by the ground contact and wheel speed (rotations/time) decreases due to bearing friction, brake drag and aerodynamic drag of the rotating wheel. The computing device 8 detects the decrease in wheel speed, stops counting wheel rotations, stores and displays the takeoff roll distance as a function of a previously entered wheel diameter. There is a backup function that subtracts one or serval rotations from the measured rotations to make up for inertia based on experience of the pilot with a particular aircraft.

In order to eliminate erroneous takeoff readings a time interval can be set in the computing device 8 so that the wheel rotation counter stops counting when the number of wheel rotations has decreased in the time interval compared to an equal length previous time interval.

In order to consider specific characteristics of the aircraft 1 and the landing gear the computing device 8 can be programmed to subtract a predetermined number of wheel rotations from the number of counted wheel rotations to display a calibrated takeoff roll.

In an advantageous embodiment the speed and distance travelled measured by the sensor pod 2 is monitored by a GPS receiver. The computing device 8 then computes a takeoff roll distance from the distance computed by the wheel rotation sensor and can use the distance measured by the GPS receiver from rotation start to rotation speed decrease as a backup and comparison.

In an advantageous embodiment the speed and distance travelled computed by the computing device 8 is used to precision calibrate the GPS receiver in order to have a more precise measurement of distance travelled to climb over an obstacle, typically 50 ft.

Once the aircraft is airborne and the wheel speed has decreased the light receiver 6 has stopped counting the landing gear is typically retraced soon thereafter in an aircraft with retractable landing gear.

After takeoff the GPS receiver keeps measuring distance travelled until a certain preset altitude is reached and indicated by the GPS receiver. Typically this altitude is set at 50 ft. which is referenced in most POHs.

The measured takeoff roll and the measured distance traveled over the 50 ft. obstacle are stored in the data base of the computing device 8 together with takeoff parameters that the pilot can enter before or after a particular takeoff. These parameters include, e.g., aircraft type/engine type, flap setting: aircraft weight: runway heading, airport elevation, wind speed and direction, temperature, relative humidity, barometric pressure or QNH, 1^{st} threshold elevation; 2^{nd} threshold elevation. The 1^{st} threshold elevation and the 2^{nd} threshold elevation are measured at opposite directions of the runway and facilitate computing a slope of the runway.

The data measured for a particular takeoff includes: takeoff roll, distance to climb over 50 ft. and climb rate in ft./NM. Takeoff roll and distance to climb are typically referenced in a POH. The rate of climb in ft./NM is typically not referenced in a FM/POH since it is a function of ground speed but an important value for flying a standard instrument departure (SID). Since this value is a function of ground speed it typically has to be calculated by the pilot by hand which adds to his workload.

Once all relevant data is entered for a particular takeoff together with the measured data for takeoff roll and distance to climb 50 ft. and climb rate in ft./NM the pilot can go back to his POH and look up the same numbers in the printed or electronic performance charts and determine how far the measured values differ from the published values.

Measuring a number of takeoff runs enables the pilot to develop updated or calibrated performance charts for his aircraft electronically.

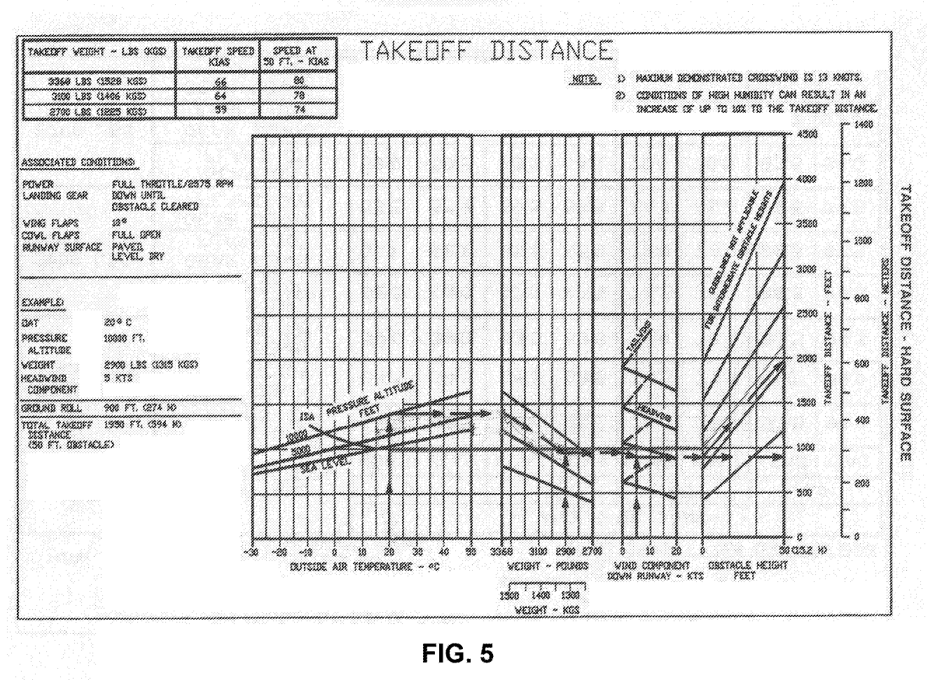

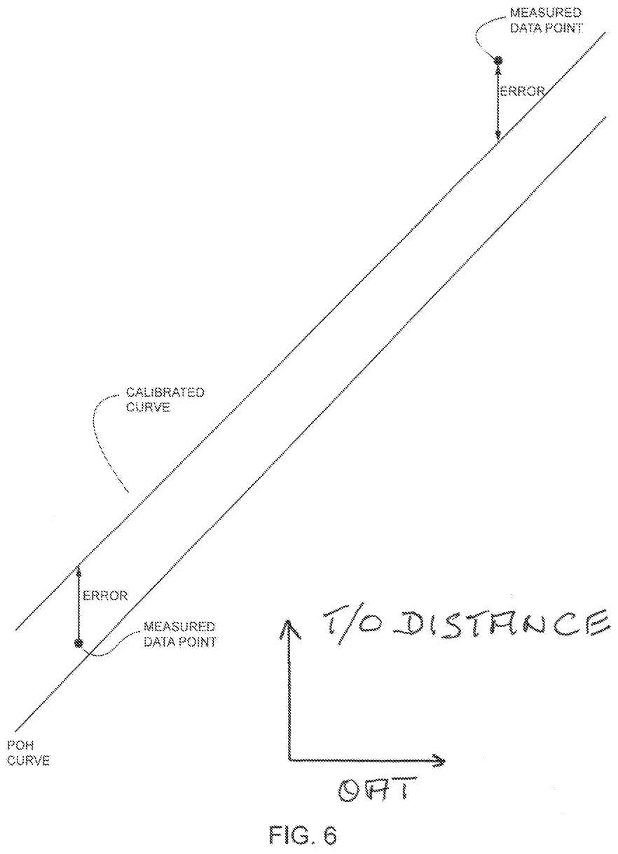

In an advantageous embodiment a measured takeoff roll distance or distance to climb over a 50 ft. obstacle is electronically entered by the computing device into a digital takeoff distance chart according to FIG. 5. reversing the computation direction indicated by the arrows in FIG. 5. In the left side diagram of FIG. 5 plotting takeoff distance over outside air temperature (OAT) a takeoff distance value is intersected with an applicable temperature value and then an applicable pressure altitude curve, thus e.g. the seal level curve, the 5000 ft. curve or the 10,000 curve is adjusted by the measured data points according to the principle of least mean squared errors illustrated in FIG. 6. The original POH pressure altitude curve is moved in parallel until the sum of mean square errors between the calibrated pressure altitude curve and the measured data points reaches a minimum. This means the shape of the existing pressure altitude curve is maintained and calibration gets more and more precise the more data points are entered. This can be done quite easily when data points for the pressure altitude curve or performance parameter curve are stored in the computing device 8 electronically. Instead of the pilot having to perform complicated and error prone interpolations on a paper performance chart or table the computing device performs all the required computations based on the new calibrated aircraft specific performance chart.

The calibrated performance chart becomes the more valuable the more a particular airplane differs from the POH e.g. through aerodynamic and engine modifications.

In aircraft with installed wheel speed sensors e.g. for anti-skid systems the wheel speed from these sensors can be used for the computing device according to the invention which can also be integrated into an on-board FMS (Flight Management System) in large transport category aircraft.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. An apparatus, configured to measure a takeoff distance of an aircraft, the apparatus comprising:
a wheel rotation sensor; and
a computing device,
wherein the wheel rotation sensor is configured to measure wheel rotations, generate a wheel rotation signal and transmit the wheel rotation signal to the computing device,
wherein the computing device is configured to start counting wheel rotations from the wheel rotation signal when the wheel rotation signal increases from zero,
wherein the computing device is configured to stop counting the wheel rotations and store a rotation count when the wheel rotation signal decreases, and wherein the computing device is configured to compute a takeoff roll distance of the aircraft from the rotation count and an aircraft wheel diameter.

2. The apparatus according to claim 1, further comprising:
a GPS receiver configured to measure a distance to climb of the aircraft from a start location and altitude where the wheel speed signal is zero to a second location where a target altitude is reached.

3. The apparatus according to claim 2, wherein one or more takeoff parameters selected from first runway threshold elevation, second runway threshold elevation, runway heading, runway surface condition, temperature, QNH, wind speed and wind direction, aircraft weight, aircraft contamination, runway condition are enterable into the computing device.

4. The apparatus according to claim 3,
wherein the takeoff parameters for a takeoff are storable in the computing device together with a measured takeoff roll distance and a measured distance to climb to generate a takeoff database, and
wherein the computing device is configured to compute a calibrated takeoff roll distance and a calibrated distance to climb for new takeoff parameters.

5. The apparatus according to claim 4, wherein the computing device is configured to electronically move a takeoff parameter curve in a memory to generate a calibrated takeoff parameter curve so that mean square deviations between the calibrated takeoff parameter curve and measured values for takeoff roll and distance to climb are minimized.

6. The apparatus according to claim 1, wherein the wheel speed sensor detects a light beam reflection from a reflective target that is mounted on a tire of the aircraft.

7. The apparatus according to claim 6, wherein the light beam is a laser beam.

8. The apparatus according to claim 6, wherein the reflective target is a reflective tape or a tire valve stem cap.

9. A method for measuring a takeoff distance of an aircraft, the method comprising:
starting a wheel rotation count when a wheel speed of the aircraft increases from zero;
stopping the wheel rotation count when the wheel speed decreases; and
computing a takeoff roll distance of the aircraft from a wheel diameter of the aircraft and the wheel rotation count.

10. The method according to claim 1, the method further comprising: reducing the wheel rotation count by a predetermined number that is a function of a rotating mass of the wheel.
